(19) United States
(12) Patent Application Publication
(10) Pub. No.: US 2010/0212932 A1
(43) Pub. Date: Aug. 26, 2010

(54) Electrical Cable

(75) Inventors: Charles D. Glore, Austell, GA (US); Clinton E. Watkins, Villa Rica, GA (US)

Correspondence Address: MERCHANT & GOULD KS, P.O. BOX 2903, MINNEAPOLIS, MN, 55402, US

(73) Assignee: Southwire Company, Carollton, GA (US)

(21) Appl. No.: 12/391,430

(22) Filed: Feb. 24, 2009

(51) Int. Cl. H01B 7/00; H01R 43/00

(52) U.S. Cl. 174/113 C; 29/825

(57) ABSTRACT

An electrical cable may be provided. The electrical cable may comprise a unilay core, a first outer conductor layer adjacent to the unilay core, and a second outer conductor layer adjacent to the first outer conductor layer. The first outer conductor layer may have a first lay direction. The second outer conductor layer may have a second lay direction opposite the first lay direction of the first outer conductor layer. The unilay core may comprise a center core strand and a first core layer adjacent to the center core strand.

### COPYRIGHTS

All rights, including copyrights, in the material included herein are vested in and the property of the Applicants. Applicants retain and reserve all rights in the material included herein, and grant permission to reproduce the material only in connection with reproduction of the granted patent and for no other purpose.

### BACKGROUND

Electrical energy is transmitted using power lines. Power lines include electrical conductors configured to conduct the electrical energy. Electrical conductors may include a plurality of stranded wires. Various stranding machines may be used to build electrical conductors from the plurality of stranded wires. Electrical conductors may be produced less expensively on stranding machines that can run faster. Moreover, electrical conductors may be produced less expensively if the stranding machines may be easily and quickly reconfigured to produce electrical conductors of different sizes.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

An electrical cable may be provided. The electrical cable may comprise a unilay core, a first outer conductor layer adjacent to the unilay core, and a second outer conductor layer adjacent to the first outer conductor layer. The first outer conductor layer may have a first lay direction. The second outer conductor layer may have a second lay direction opposite the first lay direction of the first outer conductor layer.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1A through FIG. 1D show electrical cables;

FIG. 2 is a flow chart of a method for constructing an electrical cable; and

FIG. 3A through FIG. 3D show conventional electrical cables.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

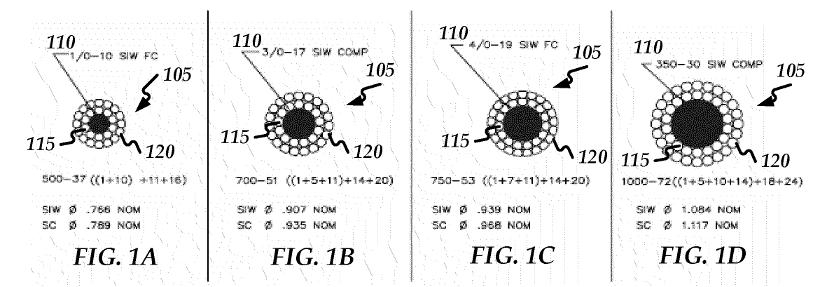

FIG. 1A, FIG. 1B, FIG. 1C, and FIG. 1D each show an electrical cable consistent with embodiments of the invention. Each of the electrical cable examples shown in FIG. 1A through FIG. 1D are similar in construction and illustrate various sizes of the electrical cable consistent with embodiments of the invention.

FIG. 1A shows an electrical cable 105 that may comprise a unilay core 110, a first outer conductor layer 115, and a second outer conductor layer 120. First outer conductor layer 115 may be adjacent to unilay core 110. First outer conductor layer 115 may have a first lay direction. Second outer conductor layer 120 may be adjacent to first outer conductor layer 115. Second outer conductor layer may have a second lay direction opposite the first lay direction of first outer conductor layer 115. While the embodiments shown in FIG. 1A through FIG. 1D show two outer conductor layers, any number of outer conductor layers may be used. In other words, one or more outer conductor layers may be used. Each successive outer conductor layer may have a lay direction opposite the lay direction of the outer conductor layer it is applied to. Moreover, each successive outer conductor layer may have a lay length longer than the lay length of the outer conductor layer it is applied to. First outer conductor layer 115, second outer conductor layer 120, and any successive outer conductor layers may be applied, for example, by a “reverse concentric” process. First outer conductor layer 115 may comprise a plurality of conductor strands. Similarly, second outer conductor layer 120 may comprise a plurality of conductor strands.

Unilay core 110 may comprise a center core strand and a first core layer adjacent to the center core strand. A second core layer may be applied to the first core layer and a third core layer may be applied to the second core layer. Any number of core layers may be used. Each successive core layer may have a lay direction and a lay length the same as the lay direction and the lay length of the preceding core layer it is applied to. Consequently, all core layers (e.g. the first core layer, the second core layer, and the third core layer) may have the same lay direction and may have the same lay length. Accordingly, unilay core 110 made in a unilay configuration may be manufactured faster and less expensively than if it where made in a reverse concentric process where any successive layer may have an opposite lay direction and a longer lay length than a preceding layer. Furthermore, unilay core 110 may comprise a commercially available and usable electrical conductor (e.g. electrical cable.)

FIG. 1A shows electrical cable 105 having a 500 MCM size with unilay core 110 having a 1/0 AWG size. Unilay core 110 in FIG. 1A may have a center core strand and a first core layer adjacent to the center core strand. In this example, the first core layer may comprise ten strands. First outer conductor layer 115 may comprise eleven strands and second outer conductor layer 120 may comprise sixteen strands in this example. All strands in unilay core 110 may be 0.114 inches in diameter. All strands in first outer conductor layer 115 and in second outer conductor layer 120 may be 0.128 inches in diameter. Unilay core 110 in FIG. 1A may comprise a 1/0 AWG size electrical conductor that may by itself be used as an electrical conductor for a power line in the electric power industry.

FIG. 1B shows electrical cable 105 having a 700 MCM size with unilay core 110 having a 3/0 AWG size. Unilay core 110 in FIG. 1B may have a center core strand, a first core layer adjacent to the center core strand, and a second core layer adjacent to the first core layer. In this example, the first core layer may comprise five strands and the second core layer may comprise eleven strands. First outer conductor layer 115 may comprise fourteen strands and second outer conductor layer 120 may comprise twenty strands in this example. All strands in unilay core 110 may be 0.114 inches in diameter. All strands in first outer conductor layer 115 and in second outer conductor layer 120 may be 0.128 inches in diameter. Unilay core 110 in FIG. 1B may comprise a 3/0 AWG size electrical conductor that may by itself be used as an electrical conductor for a power line in the electric power industry.

FIG. 1C shows electrical cable 105 having a 750 MCM size with unilay core 110 having a 4/0 AWG size. Unilay core 110 in FIG. 1C may have a center core strand, a first core layer adjacent to the center core strand, and a second core layer adjacent to the first core layer. In this example, the first core layer may comprise seven strands and the second core layer may comprise eleven strands. First outer conductor layer 115 may comprise fourteen strands and second outer conductor layer 120 may comprise twenty strands in this example. All strands in unilay core 110 may be 0.114 inches in diameter. All strands in first outer conductor layer 115 and in second outer conductor layer 120 may be 0.128 inches in diameter. Unilay core 110 in FIG. 1C may comprise a 4/0 AWG size electrical conductor that may by itself be used as an electrical conductor for a power line in the electric power industry.

FIG. 1D shows electrical cable 105 having a 1,000 MCM size with unilay core 110 having a 350 MCM size. Unilay core 110 in FIG. 1D may have a center core strand, a first core layer adjacent to the center core strand, a second core layer adjacent to the first core layer, and a third core layer adjacent to the second core layer. In this example, the first core layer may comprise five strands, the second core layer may comprise ten strands, and the third core layer may comprise fourteen strands. First outer conductor layer 115 may comprise eighteen strands and second outer conductor layer 120 may comprise twenty-four strands in this example. All strands in unilay core 110 may be 0.114 inches in diameter. All strands in first outer conductor layer 115 and in second outer conductor layer 120 may be 0.128 inches in diameter. Unilay core 110 in FIG. 1D may comprise a 350 MCM size electrical conductor that may by itself be used as an electrical conductor for a power line in the electric power industry.

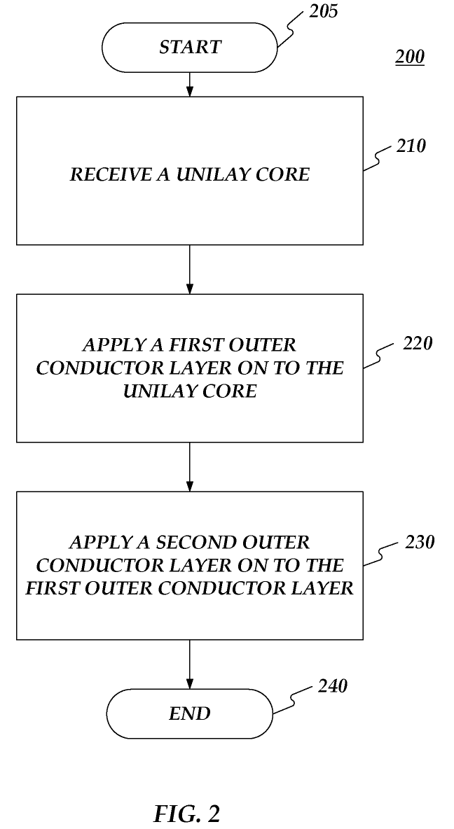

FIG. 2 is a flow chart setting forth the general stages involved in a method 200 consistent with embodiments of the invention for constructing an electrical cable. Method 200 may be implemented using a rigid-frame strander implementing a reverse concentric process for example. Ways to implement the stages of method 200 will be described in greater detail below.

To make an electrical cable on a rigid-frame strander, a single strand may be fed into the rigid-frame strander and successive strand layers may be simultaneously added to the single strand in a reverse concentric process. For example, a first layer added to the single strand may have the shortest lay length of all the layers in the electrical cable. A next layer added to the first layer may have a lay direction opposite to a lay direction of the first layer and a lay length that may be longer than a lay length of the first layer. The process may be continued with each successive layer having a lay direction opposite to and a lay length longer than the preceding layer to which it is applied.

As stated previously, each layer applied by the rigid-frame strander may be applied in a reverse concentric process. In the reverse concentric process, each layer's lay direction may be reversed after a predetermined amount of electrical cable is made on the rigid-frame strander. Consequently, the speed at which the rigid-frame strander can make the electrical cable may be a function of how fast it can twist the shortest lay length layer on the electrical cable and reverse back this shortest lay length layer. In other words, the longer the lay length of a layer, the faster the rigid-frame strander can twist that layer onto the electrical cable. Accordingly, the speed at which the rigid-frame strander operates may be a function of the lay length of the shortest lay length layer it is set up to apply. The shortest lay length layer may comprise the center-most layer in the electrical cable being manufactured.

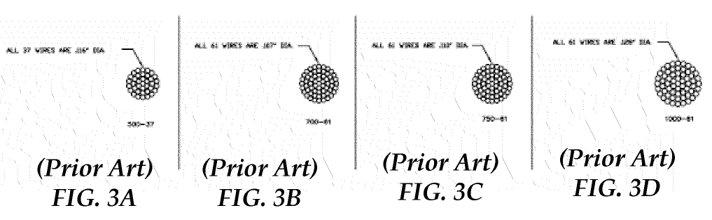

FIG. 3A through FIG. 3D show various sizes of electrical cable made in a conventional manner on a rigid-frame strander in a reverse concentric process. When making these conventional electrical cables in a conventional way, the rigid-frame strander's speed is limited by the lay length of the inner most layer. Moreover, to make a conventional 500 MCM electrical cable of FIG. 3A in a conventional process, all the strands comprise a 0.116 inch size. To make a conventional 700 MCM electrical cable of FIG. 3B in a conventional process, all the strands comprise a 0.103 inch size. Furthermore, to make a conventional 750 MCM electrical cable of FIG. 3C in a conventional process, all the strands comprise a 0.113 inch size. In addition, to make a conventional 1,000 MCM electrical cable of FIG. 3D in a conventional process, all the strands comprise a 0.128 inch size. Consequently, in the conventional process, to change the rigid-frame strander to make these different sizes shown in FIG. 3A through FIG. 3D, bobbins on the rigid-frame strander must be changed to have the correct strand size on the rigid-frame in order to make the corresponding electrical cable. Changing bobbins on the rigid-frame strander is an expensive, laborious, and time consuming process.

Method 200 may begin at starting block 205 and proceed to stage 210 where the rigid-frame strander may receive unilay core 110. Unilay core 110 may be manufactured on a “double-twist strander” to, for example, either ASTM B836 or B901. Unilay core 110 may be made at a much faster line speed, at a much lower standard cost on a double-twist strander in a unilay configuration than if it were made on a rigid-frame strander in a reverse concentric process. Unilay core 110 may comprise a commercially available and usable electrical conductor (e.g. electrical cable.) For example, 1/0 AWG unilay core 110 shown in FIG. 1A may comprise a 1/0 AWG electrical conductor that may be used as an electrical conductor for a power line. In other words, unilay core 110 may be itself a viable electrical cable used in the electric utility industry.

From stage 210, where the rigid-frame strander receives unilay core 110, method 200 may advance to stage 220 where first outer conductor layer 115 may be applied adjacent to unilay core 110. First outer conductor layer 115 may be applied in a first lay direction. For example, first outer conductor layer 115 may be applied in a reverse concentric process by the rigid-frame strander onto unilay core 110. First outer conductor layer 115 may comprise a plurality of strands each having approximately a 0.128 inch diameter.

Once first outer conductor layer 115 is applied adjacent to unilay core 110 in stage 220, method 200 may continue to stage 230 where second outer conductor layer 120 may be applied adjacent to first outer conductor layer 115. Second outer conductor layer 120 may be applied in a second lay direction opposite the first lay direction. For example, second outer conductor layer 120 may be applied in a reverse concentric process by the rigid-frame strander onto first outer conductor layer 115. Second outer conductor layer 120 may comprise a plurality of strands each having approximately a 0.128 inch diameter. Once second outer conductor layer 120 is applied adjacent to first outer conductor layer 115, method 200 may then end at stage 240.

Consistent with embodiments of the invention, because only the outer two layers of electrical cable 105 (e.g. first outer conductor layer 115 and second outer conductor layer 120) may be applied using the rigid-frame strander in a reverse concentric process, electrical cable 110 may be constructed at a faster line speed than those shown in FIG. 3A through FIG. 3D. In other words, by using unilay core 110 manufactured on a double-twist strander in a unilay configuration for a substantial portion of electrical cable 110, only a portion of electrical cable 110 may be applied by the rigid-frame strander in a reverse concentric process. Because only a portion of electrical cable 110 (and not all of electrical cable 110) may be constructed on the rigid-frame strander in a reverse concentric process, electrical cable 110 may be constructed on the rigid-frame strander at a faster line speed than if all of cable electrical cable 110 were constructed on the rigid-frame strander in a reverse concentric process. Consequently, the line speed of the rigid-frame strander configured to produce electrical cable 110 may be limited to the lay length of first outer conductor layer 115.

In other words, consistent with embodiments of the invention, a core may be used to replace a portion of an electrical cable. The replaced portion may be that portion of the electrical cable that would have had the shortest lay length layers. Now the rigid-frame strander does not have to apply the shortest lay length layers because the core has taken their place. The rigid-frame strander's line speed may now be limited by the outer layers' lay lengths that are longer than the lay lengths of layers of the replaced portion. Now the electrical cable can be produced at a faster line speed because the rigid-frame strander may now be limited by the outer layers' lay lengths that are longer than the lay lengths of the portion replaced by the core.

Furthermore, the rigid frame strander may be easily reconfigured when switched between producing any of the electrical cable configurations shown in FIG. 1A through FIG. 1D. As shown in FIG. 1A through FIG. 1D, first outer conductor layer 115 and second outer conductor layer 120 may each respectively comprise a plurality of strands having a 0.128 inch size. Because each of the electrical cable 110 sizes shown in FIG. 1A through FIG. 1D may be produced by method 200 with first outer conductor layer 115 and second outer conductor layer 120 comprising 0.128 inch strands, bobbins on the rigid-frame strander holding the 0.128 inch strands need not be changed out when switching between electrical cable 110 sizes.

Changing bobbins on the rigid-frame strander is an expensive, laborious, and time consuming process. When switching between producing any of the conventional electrical cable configurations shown in FIG. 3A through FIG. 3D, bobbins need to be changed on the rigid-frame strander in conventional processes. For example, to make a conventional 500 MCM electrical cable of FIG. 3A, bobbins with strands comprising a 0.116 inch size are needed. To make a conventional 700 MCM electrical cable of FIG. 3B, bobbins with strands comprising a 0.103 inch size are needed. To make a conventional 750 MCM electrical cable of FIG. 3C, bobbins with strands comprising a 0.113 inch size are needed. And, to make a conventional 1,000 MCM electrical cable of FIG. 3D, bobbins with strands comprising a 0.128 inch size are needed. Changing bobbins on the rigid-frame strander to switch between making the conventional electrical cables of FIG. 3A through FIG. 3D is an expensive, laborious, and time consuming process. Consistent with embodiments of the invention, however, bobbin switching may not be needed when reconfiguring the rigid-frame strander to switch between making the different sizes shown in FIGS. 1A through 1D, for example.

While certain embodiments of the invention have been described, other embodiments may exist. Further, any disclosed methods' stages may be modified in any manner, including by reordering stages and/or inserting or deleting stages, without departing from the invention. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. An electrical cable comprising:
a unilay core;
a first outer conductor layer adjacent to the unilay core, the first outer conductor layer having a first lay direction; and
a second outer conductor layer adjacent to the first outer conductor layer, the second outer conductor layer having a second lay direction opposite the first lay direction of the first outer conductor layer.

2. The electrical cable of claim 1, wherein the first outer conductor layer comprises eleven strands and the second outer conductor layer comprises sixteen strands.

3. The electrical cable of claim 1, wherein the first outer conductor layer comprises fourteen strands and the second outer conductor layer comprises twenty strands.

4. The electrical cable of claim 1, wherein the first outer conductor layer comprises eighteen strands and the second outer conductor layer comprises twenty-four strands.

5. The electrical cable of claim 1, wherein the unilay core comprises:
a center core strand; and
a first core layer adjacent to the center core strand.

6. The electrical cable of claim 5, wherein the first core layer comprises ten strands.

7. The electrical cable of claim 1, wherein the unilay core comprises:
a center core strand;
a first core layer adjacent to the center core strand; and
a second core layer adjacent to the first core layer.

8. The electrical cable of claim 7, wherein the first core layer comprises five strands and the second core layer comprises eleven strands.

9. The electrical cable of claim 7, wherein the first core layer comprises seven strands and the second core layer comprises eleven strands.

10. The electrical cable of claim 1, wherein the unilay core comprises:
a center core strand;
a first core layer adjacent to the center core strand;
a second core layer adjacent to the first core layer; and
a third core layer adjacent to the second core layer.

11. The electrical cable of claim 10, wherein the first core layer comprises five strands, the second core layer comprises ten strands, and the third core layer comprises fourteen strands.

12. The electrical cable of claim 1, wherein the unilay core comprising a plurality of strands each having approximately a 0.114 inch diameter.

13. The electrical cable of claim 1, wherein the first outer conductor layer comprises a plurality of strands each having approximately a 0.128 inch diameter.

14. The electrical cable of claim 1, wherein the second outer conductor layer comprises a plurality of strands each having approximately a 0.128 inch diameter.

15. The electrical cable of claim 1, wherein the unilay core comprises a 1/0 AWG size and the electrical cable comprises a 500 MCM size.

16. The electrical cable of claim 1, wherein the unilay core comprises a 3/0 AWG size and the electrical cable comprises a 700 MCM size.

17. The electrical cable of claim 1, wherein the unilay core comprises a 4/0 AWG size and the electrical cable comprises a 750 MCM size.

18. The electrical cable of claim 1, wherein the unilay core comprises a 350 MCM size and the electrical cable comprises a 1,000 MCM size.

19. The electrical cable of claim 1, wherein the unilay core comprises one of the following sizes: 1/0 AWG, 3/0 AWG, 4/0 AWG, and 350 MCM.

20. The electrical cable of claim 1, wherein the electrical cable comprises one of the following sizes: 500 MCM, 700 MCM, 750 MCM, and 1,000 MCM.

21. An electrical cable comprising:
a unilay core comprising one of the following sizes: 1/0 AWG, 3/0 AWG, 4/0 AWG, and 350 MCM, the unilay core comprising,
a center core strand having approximately a 0.114 inch diameter, and
a first core layer adjacent to the center core strand, the first core layer comprising a first plurality of strands each having approximately a 0.114 inch diameter;
a first outer conductor layer adjacent to the unilay core, the first outer conductor layer having a first lay direction, wherein the first outer conductor layer comprises a second plurality of strands each having approximately a 0.128 inch diameter; and
a second outer conductor layer adjacent to the first outer conductor layer, the second outer conductor layer having a second lay direction opposite the first lay direction of the first outer conductor layer, wherein the second outer conductor layer comprises a third plurality of strands each having approximately a 0.128 inch diameter, wherein the electrical cable comprises one of the following sizes: 500 MCM when the unilay core comprises a 1/0 AWG size, 700 MCM when the unilay core comprises a 3/0 AWG size, 750 MCM when the unilay core comprises a 4/0 AWG size, and 1,000 MCM when the unilay core comprises a 350 MCM size.

22. A method for constructing an electrical cable, the method comprising:
receiving a unilay core comprising,
a center core strand having approximately a 0.114 inch diameter, and
a first core layer adjacent to the center core strand, the first core layer comprising a first plurality of strands each having approximately a 0.114 inch diameter;
applying, in a reverse concentric process, a first outer conductor layer on to the unilay core, wherein the first outer conductor layer comprises a second plurality of strands each having approximately a 0.128 inch diameter; and
applying, in the reverse concentric process, a second outer conductor layer on to the first outer conductor layer, wherein the second outer conductor layer comprises a third plurality of strands each having approximately a 0.128 inch diameter, wherein the electrical cable comprises one of the following sizes: 500 MCM, 700 MCM, 750 MCM, and 1,000 MCM.
